(19) United States
(12) Patent Application Publication
(10) Pub. No.: US 2023/0059383 A1
(43) Pub. Date: Feb. 23, 2023

(54) CONNECTOR HOUSING, PROCESS FOR PRODUCING THE SAME AND A MOLD FOR USING IN THE PROCESS

(71) Applicant: DSM IP Assets B.V., HEERLEN (NL)

(72) Inventor: See-Wee ONG, ECHT (NL)

(21) Appl. No.: 17/797,507

(22) PCT Filed: Feb. 4, 2021
(86) PCT No.: PCT/EP2021/052666

§ 371 Date: Aug. 4, 2022

(30) Foreign Application Priority Data
Feb. 5, 2020 (CN) PCT/CN2020/074330
Feb. 9, 2020 (EP) 20156269.1

(51) Int. Cl. H01R 43/24; B29C 45/00; B29C 45/27; H01R 12/77; H01R 13/50

(52) U.S. Cl. CPC H01R 43/24; B29C 45/0005; B29C 45/2708; H01R 12/774; H01R 13/50; B29C 2045/0027; B29K 2077/00

(57) ABSTRACT

The present invention relates to an FPC connector housing, more particular to a DDRS connector housing. The invention also relates to a method for producing the connector housing as well as to a cavity mold suitable for the production of the connector housing. The cavity mold comprises a double gating system with centrally positioned injection gates. The connector housing can be used in a connector for mounting on a flexible printed circuit (FPC) assembled in various kinds of electrical and/or electronic devices.

The present invention relates to a connector housing for use in electric and/or electronic devices, more particular to a fine pitch connector housing, such as a DDR connector housing, comprising two opposing walls and an array of insertion holes between the opposing walls, and which holes define a passageway for receiving an insert with contact pins. The invention also relates to a process for producing the connector housing as well as to a cavity mold suitable for the production of the connector housing. The connector housing can be used in an electrical connector for mounting on a printed circuit board (PCB) and be assembled in various kinds of electrical and/or electronic devices.

Modern high-density electronic applications like computer servers, laptops and cell phones make use of compact electronic components mounted on printed circuit board (PCB) and integrated into larger assemblies. Printed circuit boards (PCBs) typically comprise etched or printed circuits that incorporate components mounted onto a rigid or flexible material. The PCBs made of flexible materials are also known as flexible printed circuits (FPC). The mounting of the components on a PCB is typically done by reflow soldering processes. The connection of the components on the PCB with other components may be accomplished via electrical connectors mounted on the PCB. These electrical connectors can be employed, for example, to detachably mount a central processing unit (“CPU”) to a printed circuit board. The connectors may also be used, for example, for integrating different PCBs, or for integrating PCBs with other components, by using connector cables between the connectors on different PCBs, or between a connector on a PCB and another component. For such connector cables often flexible flat cables (FFCs) are used. FFCs are usually straight connections without any components, which are flat and flexible, and are a miniaturized form of ribbon cables. These FFCs may comprise an array of a large number of conductors.

Electrical connectors as referred to above typically comprise a plastic housing, made of an injection molded thermoplastic material, comprising two opposing walls and an array of insertion holes between the opposing walls, each hole comprising a conducting element or giving access to a conducting element, and which holes define a passageway for receiving an insert with contact elements. The insert can come, for example, from an array of contact pins on a CPU or from an array of conductors in an end-section of an FFC.

The spacing of the insertion holes in a connector housing has to match those of the conductors in the FFC or the contact pins on the CPU. This spacing is referred to as the pitch. The pitch of an electrical connector typically refers to the distance from the center of one insertion hole in the connector housing to the center of its neighboring insertion hole. Newer generations of connectors typically have a larger number of pin insertion holes and a smaller pitch or smaller distance between pin insertion holes.

There are different types of electrical connectors with a small pitch. Examples thereof are DDR, SODIMM and PCI connectors. All these connectors have a long form factor. One type of such connectors are the DDR connectors, including DDR2, DD3 and DDR 4, and more recently DDR5. The DDR connectors, including the DDR 5 connector, typically have a length of 141 mm. The DDR connectors typically have a pitch of in a range between 0.85 and 1 mm. In particular, the pitch in the DDR5 and DDR4 connectors is typically 0.85 mm and of the DDR3 connector is 1 mm. DDR stands for Double Data Rate. These connectors are often used for memory cards, recognizable by the extension SDRAM which stands for Synchronous Dynamic Random-Access Memory. Each generation of the DDR SDRAM connectors requires its own interface and appropriate technologies and is aimed at a high data transfer speed. Furthermore, with the new generations, aiming at higher data transfer speeds and requiring a higher bandwidth (“double data rate”) interface, the size of the connectors also changes in terms of increasing length of the connector, increasing number of conducting elements and reduced pitch between the conducting elements.

The modern electrical connectors of the kinds mentioned above have been widely adopted and utilized for smart phones, digital cameras, game machines, servers and desk tops and other kinds of electrical and/or electronic devices, which keep getting smaller and smaller. The dimensional reduction of these applications has been made possible in part due to the small dimensions in width and height directions of the connector housings.

Compared to DDR4, DDR5 further reduces typically the memory module voltage to 1.1 V, thus reducing power consumption. DDR5 modules can incorporate on-board voltage regulators in order to reach higher speeds. DDR5 can support a speed of 51.2 GB/s per module and 2 memory channels per module. There is a general expectation that most use-cases which currently use DDR4 will eventually migrate to DDR5. Since the E&E industry is characterized by a steady trend towards further miniaturization leading to smaller connectors, and increasing performance level, this development will continue with new generations, such as DDR6 and DDR7 still to come.

Connector housings are typically made of electrically isolating materials, more particular from plastic materials, for example, thermoplastic compositions based on thermoplastic polyester or thermoplastic polyamide. These compositions may comprise further components, for example reinforcing fibers, for example glass fibers, or fillers, for example talc and mica, or flame retardant, or a combination of reinforcing fibers and fillers. Reinforcing fibers and fillers are well-known in the art. For the polyesters, liquid crystalline polyesters have been a preferred choice. As polyamide, aliphatic polyamides have been widely used. More recently, compositions based on thermoplastic semi-crystalline semi-aromatic polyamides (this polyamide referred to herein as PPA) have become of more importance, not the least since these constitute a better comprise in high temperature performance and price.

The connector housings are typically manufactured by injection molding a thermoplastic composition via a runner and gating system through a gate into a cavity defined by a mold. A standard lay-out of a mold design for connector housings comprises a double gating system wherein the cavity defines the shape of the connector housing having a length direction and the two gates of the double gating system are positioned at the one end of the connector housing, i.e. at one end of the length direction.

However, these dimensional requirements in terms of small width and small height next to a relatively large length, in combination with material requirements and severe process conditions during reflow soldering, also create problems in terms of dimensional integrity of the housing. With dimensional integrity is herein meant that the connector housing, when being produced should have the intended shape as defined by the mold used for the production of the connector housing, and that the connector housing should retain that shape after reflow soldering.

A problem with connectors with small dimensions is that these tend to warp or bend. This problem can already occur after the injection molding process, and more typically occurs or becomes more emphasized when the connector goes through a temperature cycle, such as applied during soldering for surface mounting of the connector on other parts.

With warpage is herein understood that the molded part is deformed or out of shape, for example bent or twisted. Warpage, or warp or twist of the connector socket, will lead to stresses in the surface mounted assembly. Furthermore, warpage can lead to defects in the reflow soldering process and to problems with open circuit with the PCB after reflow, with the insertion of the contact pins on a CPU or insertion of the end-section of an FFC. These problems result in difficulties with the insertion itself or result in mechanical damage of the housing or insufficient pin retention force, or a combination thereof. Increasing the mechanical strength and stiffness of the molded part by, for example, increasing the content of fiber reinforcement, which often has to be used in combination with a sufficiently high amount of flame retardant in the molding composition to comply with flame retardancy requirements, generally increases the warpage and often creates molding problems.

The problems of warpage of the housing, either directly after molding, or after soldering, are more outspoken with the newer generation connector housings, i.e. DDR 5 type connection housings made by injection molding show more problems with warpage than for example DDR4 type connection housings made by injection molding. The same holds for other connector housings with a large length/height ratio. These problems are also more outspoken with thermoplastic compositions based on thermoplastic semi-crystalline semi-aromatic polyamides (this composition referred to herein as PPA composition), and do already occur, if process conditions are not fully optimized, with DDR4 type connection housings made by injection molding.

Furthermore, when such PPA compositions are used for the production of DDR5 connection housings by injection molding, the molded parts show problems with surface quality, such as fiber print through, sink mark, and localized porosity.

Another problem with mold designs is occurrence of weld lines resulting from the flow pattern of the injection molded material injected into the cavity. Such flow patterns can be complex and weld lines are difficult to avoid. Weld lines typically result in localized reduced mechanical properties. When the weld lines occur at critical spots in the molded part, this can lead to failure of the molded part during mounting or assembling.

A further problem is a limitation in production capacity, when producing DDR5 type connectors, in particular when using a polyamide composition, in particular when using a PPA composition.

In view of the above there need for a solution for connector housing that results in less warpage, when the part is produced as well as after reflow soldering, that has good mechanical properties and that, when made of a PPA-composition, shows improved surface quality. There is also a need for the possibility to increase the production capacity when producing a DDR5 type connector from a polyamide composition.

Therefore the goal of the present invention is to provide a connector housing that has a good dimensional integrity and good mechanical properties. Another goal is to provide a process for making a connector housing that has a good dimensional integrity and good mechanical properties. A further aim is to provide a process for making a connector housing based on a PPA composition and for a connector housing made by that process that has a good dimensional integrity and good mechanical properties as well as a good surface quality. A further aim is to provide a process producing a DDR5 type connector from a polyamide composition that allows for a higher production capacity.

These goals have been achieved with the following embodiments of to the present invention, which includes
A mold as defined in claim 1, designed for use in the process for producing the connector housing;
A process as defined in claim 5 for producing a connector housing by injection molding of a thermoplastic polymer composition;
A connector housing as defined in claim 8, made of a thermoplastic polymer composition.

The invention also includes an electrical connector comprising the said connector housing, and an electrical and/or electronic device comprising said electrical connector.

The mold according to the present invention is a cavity mold for use in an injection molding process, comprising a cavity defining a shape of a connector housing and injection channels with a double gating system comprising two injection gates, wherein the two injection gates are located at opposite sides of the cavity, each located near or at the middle of the length direction of the cavity.

The cavity mold comprises at least one cavity for forming a connector housing, and a double gating system with two injection gates for each of the at least one cavity, wherein the two injection gates for a specific cavity are located at opposite sides of said specific cavity and at a position near or at the middle of the length direction of the cavity.

With a gate is herein understood the opening in a mold through which molten plastic material is injected into the cavity. It is the boundary between cavity and the injection channels and also constitutes the boundary between the molded part produced in the cavity and the scrap formed in the injection channels. The injection channels suitable comprise different segments, such as a so-called sprue and runners.

In a preferred embodiment, wherein the cavity mold comprises hot runners in connection to the two injection gates. With hot runners are herein understood injection channels that can be heated during injection molding. The advantage of heating the hot runners of the injection channels during injection molding is better product is produced and less material is used and less waste material produced due to absence of a cold runner.

In another preferred embodiment, the at least one cavity is designed for forming a DDR connector housing, more preferably for forming a DDR 4 or a DDR 5 connector housing, more preferably a DDR 5 connector housing. This latter makes the mold ultimately suited for the production of DDR 5 connector housings. Meanwhile, the problems of warpage and surface quality underlying the present invention as described above are reduced. For that purpose, the cavity, or cavities, in case of more than one cavity in the cavity mold, have contours corresponding with DDR 4 or a DDR 5 connector housing.

In a further preferred embodiment, the mold comprises at least 4, suitably 8 to 32 cavities, preferably 8 or 16 cavities for forming a connector housing by injection molding. Next to that, the cavity mold comprises injection channels a double gating system with two injection gates for each of the cavities located at opposite sides of for each of the cavities and at a position near or at the middle of the length direction of for each of the cavities.

The cavity mold according to the present invention enables the number of cavities to be increased and has the advantage of increasing the production capacity. Even for DDR5 housing connectors made of a PPA composition suitably comprises 8 cavities, whereas for the conventional cavity mold with injection gates located at an end-position of the cavity, 8 cavities result in more molding problems and severe reduction in quality of the molded parts.

The process according to the present invention is an injection molding process for producing a connector housing, comprising injection molding of an injection molding material into a cavity mold as defined herein above.

The process suitably comprises the steps of:
Providing a cavity mold as defined herein above;
Injection molding of an injection molding material into the cavity of the mold, thereby forming an injection molded part in the cavity;
Removing the injection molded part from the mold and separating residues from the injection channels, thereby obtaining an injection molded connector housing made of the injection molding material.

During said process, the injection molding material passes through the injection channels, enters the cavity via the injection gates and fills the cavity.

The injection molding material suitably is a thermoplastic molding composition, i.e. a composition comprising thermoplastic polymer. Such a material can be melt-processed, injected as a melt into the cavity and solidified in the cavity to form the molded apart in the shape of connector housing defined by the contours of the cavity. Suitably, the thermoplastic polymer is a thermoplastic polyester or a thermoplastic polyamide, preferably a thermoplastic polyamide.

In a preferred embodiment the thermoplastic molding composition is a thermoplastic polyamide composition comprising a semi-crystalline semi-aromatic polyamide (PPA composition) or a fiber reinforced flame retardant polyamide composition, more preferably the thermoplastic molding composition is a fiber reinforced flame retardant PPA composition. The advantage of this embodiment, wherein injection molding material is a fiber reinforced flame retardant PPA composition is that, despite that this material raised more problems in production of connector housings in a process employing a conventional cavity mold, with the process according to the present invention, the problems of warpage and surface quality are reduced.

The semi-crystalline semi-aromatic polyamide (PPA) used in the PPA composition suitably has a melting temperature Tm-A of at least 280° C. Herein the melting temperature Tm-A is measured by DSC with the method according to ISO11357-1/3 with a heating and cooling rate of 20° C. Herein a first heating cycle, a cooling cycle and a second heating cycle is applied, wherein in the first heating cycle the temperature is raised to about 35° C. above Tm-A, kept at that temperature for 3 minutes, in the cooling cycle the temperature is cooled to 0° C., kept for 5 minutes at that temperature and then the second heating cycle is started. For the melting temperature Tm the peak value of the melting peak in the second heating cycle was determined.

The semi-crystalline semi-aromatic polyamide (PPA) further suitably has a crystallization enthalpy ΔHc of at least 30 J/g, preferably at least 50 J/g. Herein the crystallization enthalpy ΔHc is also measured by DSC with the method as described above. For the crystallization enthalpy ΔHc the surface under the crystallization endotherm peak in the cooling cycle from 20° C. above Tm-A to 200° C. is determined and expressed in J/g relative to the weight of the composition. The resulting value is than corrected for the percentage of polyamide polymer in the composition.

The PPA can be a homopolymer or a copolymer. Examples of homopolymers of semi-crystalline semi-aromatic polyamides are PA 8T, PA 9T and PA 10T. These polyamides can be denoted as PA XT, wherein T represents terephthalic acid; and X represents a diamine.

Examples of copolymers of semi-crystalline semi-aromatic polyamides are PA 6T/61, PA 6T/66, PA 6T/610, PA 10T/106 and PA10T/101. These polyamides can be denoted as PA XT/XZ, wherein X represents a diamine, T represents terephthalic acid, and Z represents a second dicarboxylic acid. Z can be for example, adipic acid (symbol ‘6’), isophthalic acid (symbol ‘I’) or sebacic acid (symbol ‘10’).

Other examples of copolymers of semi-crystalline semi-aromatic polyamides are PA 4T/6T, PA 6T/10T, PA6T/8T, PA6T/M5T, and PA 10T/6T. These polyamides can be denoted as PA XT/YT. Herein T represents terephthalic acid; X and Y represent different diamines.

The semi-crystalline semi-aromatic polyamide (PPA) may also be a modification of any of the above polyamides, wherein terephthalic is replaced in part or in full by naphthalene dicarboxylic acid or diphenyldicarboxcxylic acid.

The semi-crystalline semi-aromatic polyamide (PPA) may also be any copolyamide of any combination of two or more polyamides selected from the PA XT, PA XT/XZ and/or PA XT/YT polyamides mentioned above.

The PPA composition suitably is a fiber reinforced flame retardant composition comprising a polyamide polymer, a flame retardant system and a fibrous reinforcing agent, wherein
the polyamide polymer comprises at least a semi-crystalline semi-aromatic polyamide having a melting temperature Tm-A of at least 280° C.,
the flame retardant system comprises a metal salt of dialkylphosphinate and/or diphosphinate
fibrous reinforcing agent comprises glass fibers and
the composition has a heat distortion temperature of at least 265° C., measured according to ISO 75-1/2.

The advantage hereof is that the connector housing made thereof can withstand higher peak temperatures during reflow soldering while retaining a good dimensional integrity.

In another preferred embodiment, the cavity mold used in the process comprises a cavity having the contours corresponding with a DDR 4 or a DDR 5 connector housing, more preferably a DDR 5 connector housing. This latter makes the process ultimately suited for the production of DDR 5 connector housings.

In a more preferred embodiment, the mold used in the process comprises a cavity having the contours corresponding with a DDR 5 connector housing and the injection molding material is a thermoplastic composition comprising a thermoplastic semi-crystalline semi-aromatic polyamide. More preferably, in the process a cavity mold with 8 or 16 cavities, more preferably 8 cavities suited for the production of DDR 5 connector housings is used. This has the advantage that production capacity is increased while molded parts with good surface quality and low warpage are produced.

The connector housing according to the present invention is an injection molded connector housing, obtainable by the process according to the present invention by using in said process a cavity mold as defined herein above according to the present invention. Such an injection molding process leaves gating marks on the molded part. The connector is characterized by two gating marks located at opposite sides of the connector housing, each located near or at the middle of the length direction of the connector housing.

The advantage of this connector housing is that dimensional integrity is better retained while the connector has good mechanical properties, when compared with a conventional connector produced with a double gating systems with two end gates.

The connector housing suitably is a thin pitch connector housing have two opposing walls, i.e. walls in the length direction of the housing, with a thickness of less than 1 mm. Suitably, the thickness of the opposing walls in the housing according to the invention is about 800 micrometers (μm) or less, more particular about 500 μm or less. The thin pitch connector housing suitably also has intersecting walls, i.e. walls dividing the passageways and separating the contact pins. The intersecting walls typically have a thickness of less than 500 micrometers (μm). Suitably, the thickness of the intersecting walls in the housing according to the invention is about 300 μm or less, more particular of about 200 micrometers (μm) or less.

In a preferred embodiment, the connector housing is a DDR 4 or a DDR 5 connector housing, more preferably a DDR 5 connector housing.

Herein the improved retention of dimensional integrity compared with the conventional connector is even better observable.

In another preferred embodiment, the connector housing is made of a thermoplastic composition comprising a thermoplastic semi-crystalline semi-aromatic polyamide.

The advantage of this connector housing is not only that dimensional integrity is better retained while the connector has good mechanical properties, but also that the molded parts has a better surface quality and less surface defects.

In a more preferred embodiment, the connector housing is a DDR 5 connector housing made of thermoplastic composition comprising a thermoplastic semi-crystalline semi-aromatic polyamide.

Herein the connector housing not only has good mechanical properties and a better surface quality with less surface defects, but also the improvement in retention of dimensional integrity compared with the conventional connector is even better observable.

The present invention also relates to the use of the connector housing in an electrical connector, and to an electrical connector.

The present invention further relates to the use of an electrical connector in electrical and/or electronic device, and to an electrical and/or electronic device comprising said electrical connector.

The use of a connector housing in an electrical connector according to the invention implies the use of the connector housing according to the present invention, which is obtainable by the injection molding process according to the present invention and involves the use of the cavity mold according to the present invention. Said connector housing is an injection molded connector housing having gating marks located at opposite sides of the housing and at a position near or at the middle of the length direction of the housing.

With the expression at the middle is herein understood the position at equidistance from the two ends of the connector housing. If the length of the connector housing, measured from end-to-end, is L, the distance from the position at the middle to each end is half of that, thus L/2. Thus, the melt flow length to fill the cavity can be considered in this case reduced by half. With the expression near the middle is herein understood a position that is closer to the middle than to one of the ends. Suitably, the position of the gating marks is within a distance from the midpoint in a range of (0-0.15)*L, preferably in the range of (0-0.10) *L, more preferably in the range of (0-0.05) *L. Most preferably, the position of the gating marks is at the middle of the length direction of the housing, i.e. the distance from the middle is 0*L; in other words the distance from the middle equal to zero.

The electrical connector according to the present invention comprises the connector housing as described herein above, or any particular or preferred embodiment thereof, and metallic or other conductive elements therein. It has the advantages of the connector housing as mentioned herein above and shows reduced warpage problems during mounting in a reflow soldering process applied to make a surface mounted device. Suitably, the electrical connector is a DDR5 connector.

The electrical connector according to the present invention is suitably used in an electrical and/or electronic device. More particular, electrical connector is suitably used in a surface mounting process surface mounted device, the process comprising a reflow soldering. In the reflow soldering process, the temperature peak can be as high as 260° C. or 270° C.

The electrical and/or electronic device according to the present invention comprises the electrical connector as described herein above, or any particular or preferred embodiment thereof. Suitably, the electrical connector is a DDR5 connector.

The invention is further illustrated with the following figures.

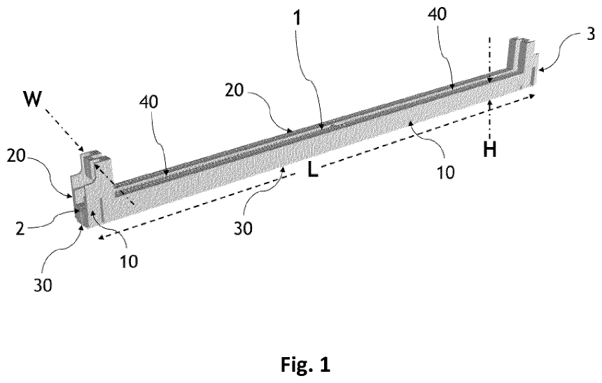

FIG. 1 is a part isometric view of a DDR connector.

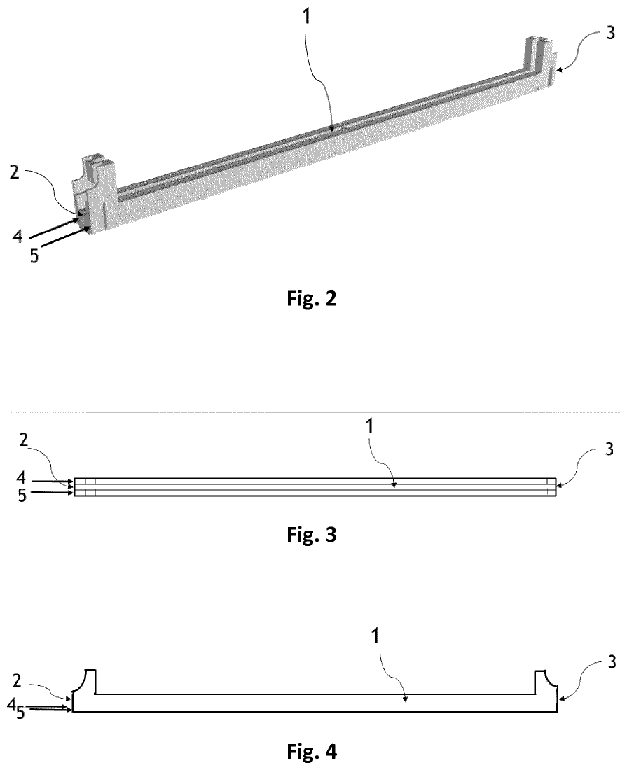

FIG. 2 is a part isometric view of a DDR connector showing the position of conventional injection gates.

FIGS. 3 and 4 are schematic drawings 2 of a DDR connector showing the position of conventional injection gates.

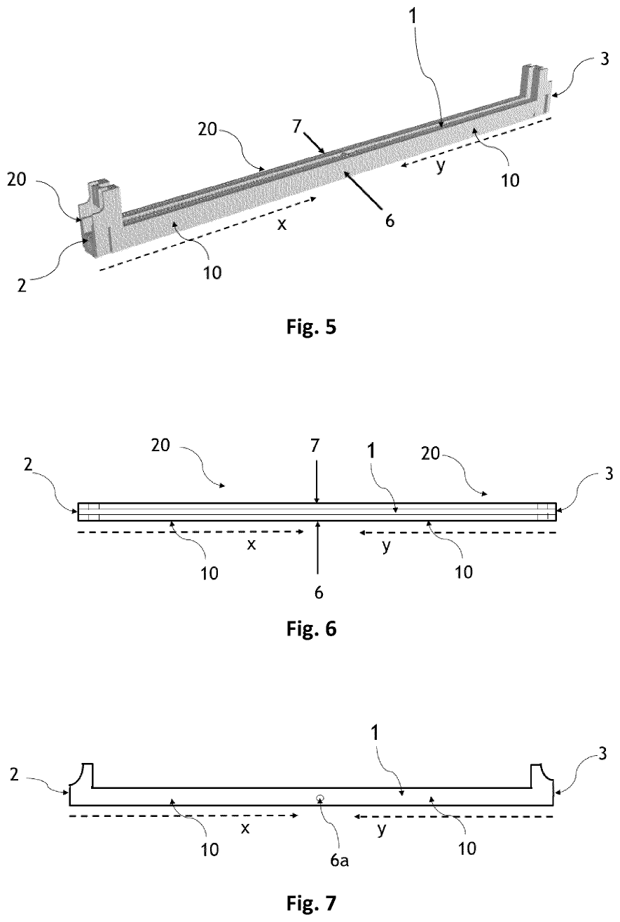

FIG. 5 is a part isometric view of a DDR connector showing the position of the injection gates according to the present invention.

FIGS. 6 and 7 are schematic drawings 2 of a DDR connector showing the position of injection gates according to the present invention.

FIG. 1 shows a part isometric view of a DDR connector housing.

FIG. 2 shows a part isometric view of a DDR connector housing showing the position of conventional injection gates.

FIGS. 3 and 4 are schematic drawings 2 of a DDR connector housing showing the position of conventional injection gates.

FIG. 5 shows a part isometric view of a DDR connector housing showing the position of the injection gates according to the present invention.

FIGS. 6 and 7 are schematic drawings 2 of a DDR connector housing showing the position of injection gates according to the present invention.

FIG. 1 shows a part isometric view of a DDR connector housing (1). Herein the connector housing (1) has elongated body with two end parts (2) and (3), two opposing sides being a front side (10) and a back side (20), a bottom (30) and a top side (40). The shape of housing is defined by three main dimensions, being the length (L), the width (W) and the thickness (T), wherein L is much larger than T and W.

FIG. 2 shows a part isometric view of a DDR connector housing (1) showing the conventional positioning of injection gates (4) and (5) at one end part (2) of the connector housing (1).

FIG. 3 is a schematic top view of a DDR connector housing (1) showing the conventional positioning of injection gates (4) and (5) at one end part (2) of the connector housing (1).

FIG. 4 is a schematic side view of a DDR connector housing (1) showing the conventional positioning of injection gates (4) and (5) at one end part (2) of the connector housing (1).

FIG. 5 shows a part isometric view of a DDR connector housing (1) showing the positioning of injection gates (6) and (7) at opposite sides (10) and (20) of the connector housing (1) at a position at the middle or near the middle of the connector housing (1).

FIG. 6 is a schematic top view of a DDR connector housing (1) showing the positioning of injection gates (6) and (7) at opposite sides (10) and (20) of the connector housing (1) at a position at or near the middle of the connector housing (1).

FIG. 7 is a schematic side view of a DDR connector housing (1) showing the position of an injection gate mark (6a) at one side (10) of the connector housing (1) at a position at or near the middle of the connector housing (1). The gate mark of the other injection position is not visible in this view since the gate mark is located at the opposite side (20) not visible in this view.

1. Cavity mold for use in an injection molding process, the cavity mold comprising
at least one cavity for forming a connector housing by injection molding, and
injection channels with a double gating system with two injection gates for each of the at least one cavity,
wherein the two injection gates are located at opposite sides of the cavity and at a position near the middle of the length direction of the cavity that is the position that is closer to the middle than to one of the ends of the connector housing or at the middle of the length direction of the cavity that is the position at equidistance from the two ends of the connector housing.

2. Cavity mold according to claim 1, wherein the cavity mold comprises hot runners in connection to the two injection gates.

3. Cavity mold according to claim 1, wherein the cavity mold comprises one or more cavities, and the cavity or the cavities, have been designed for forming a DDR5 connector housing.

4. Cavity mold according to claim 1, wherein the cavity mold has at least 4, suitably 8 to 32 cavities, preferably 8 or 16 cavities for forming a connector housing by injection molding, and two injection gates for each of the cavities, the two injection gates located at opposite sides of for each of the cavities and at a position near or at the middle of the length direction of each of the cavities.

5. Process for producing an injection molded connector housing, comprising injection molding of an injection molding material into a cavity mold as defined in claim 1.

6. Process according to claim 5, wherein the injection molding material is a thermoplastic polyamide composition, preferably a thermoplastic polyamide composition comprising a semi-crystalline semi-aromatic polyamide (PPA), or a fiber reinforced flame retardant polyamide composition, more preferably a fiber reinforced flame retardant composition comprising a PPA.

7. Process according to claim 5, wherein the mold has at least 4 cavities, preferably 8 to 32 cavities, more preferably 8 or 16 cavities.

8. Injection molded connector housing for an electrical connector, obtainable by an injection molding process using a cavity mold as defined in claim 1, wherein the injection molded connector housing has gating marks located at opposite sides of the housing and at a position near the middle of the length direction of the cavity that is the position that is closer to the middle than to one of the ends of the connector housing or at the middle of the length direction of the housing that is the position at equidistance from the two ends of the connector housing.

9. Injection molded connector housing according to claim 8, wherein the housing is made of an injection molding material comprising a semi-crystalline semi-aromatic polyamide.

10. Use of an injection molded connector housing according to claim 8 in an electrical connector or in an electrical and/or electronic device.

11. Electrical connector comprising a connector housing and metallic elements, wherein the connector housing is injection molded connector housing as defined in claim 8.

12. Electrical connector according to claim 11, wherein the connector is a DDR4 or DDR5 connector.

13. Electrical and/or electronic device comprising an electrical connector comprising a connector housing and metallic elements mounted on a printed circuit board (PCB), wherein the connector housing is an injection molded connector housing as defined in claim 11.

14. Electrical and/or electronic device according to claim 13, wherein the connector is a DDR5 connector.

15. Electrical and/or electronic device according to claim 13, wherein the device is a computer server, a laptop or a desktop.
